(19) United States
(12) Patent Application Publication
(10) Pub. No.: US 2008/0165112 A1
(43) Pub. Date: Jul. 10, 2008

(54) GATE DRIVER

(75) Inventor: Bryan Su, Kaohsiung City (TW)

Correspondence Address: J C PATENTS, INC., 4 VENTURE, SUITE 250, IRVINE, CA, 92618, US

(73) Assignee: DENMOS TECHNOLOGY INC., Hsinchu (TW)

(21) Appl. No.: 11/742,329

(22) Filed: Apr. 30, 2007

(30) Foreign Application Priority Data
Jan. 9, 2007 (TW) 96100798

(51) Int. Cl. G09G 3/36

(52) U.S. Cl. 345/100; 345/98

(57) ABSTRACT

A gate driver is provided. The gate driver generates a original signal by a signal generator, and then the original signal into a plurality of signal parts by a demultiplexer and the signal parts are transmitted into a corresponding gate channel in order to reduce the number of shift registers and level shifters of front-end circuit. Thus, the manufacturing cost of the gate driver and the space occupation of the chip can be effectively reduced.

### CROSS-REFERENCE TO RELATED APPLICATION

This application claims the priority benefit of Taiwan application serial no. 96100798, filed Jan. 9, 2007. All disclosure of the Taiwan application is incorporated herein by reference.

### BACKGROUND OF THE INVENTION

1. Field of the Invention

The present invention generally relates to a gate driver, and more particularly, to a gate driver of a display device.

2. Description of Related Art

In recent years, portable electronic devices and regular display devices have become popular with the rapid development of semiconductor technologies. Because of the advantages of low-voltage operation, non-radiation dispersion, light weight, and small size, liquid crystal displays (LCDs) have become a primary part of display devices. This results in the development of liquid crystal display technologies toward smaller size and low cost. Scanning drive circuits are playing an essential role in display panels.

FIG. 1 is a schematic circuit diagram of a scanning drive circuit of a conventional display panel. The scanning drive circuit functions to control the On/Off states of scanning lines of a display panel 6. The scanning drive circuit includes a shift register unit 10, a level shift unit 20, and an output buffer unit 40.

FIG. 2A is a schematic circuit diagram illustrating more details of a scanning drive circuit of the conventional display panel. FIG. 2B is a signal sequence chart of the conventional display panel of FIG. 2A. According to FIG. 2B, 211-out˜218-out represent output signals of shift registers 211˜218, respectively, and 221-out˜228-out represent output signals of level shifters 221˜228. The shift register unit 10 is used to receive a start pulse and a gate clock. The shift register unit 10 includes a plurality of shift registers 211˜218. The most popular shift register is D-type flip-flop, which transfers a logic state of its input to its output during each period of a clock. That is, when the shift register 211 receives a start pulse, it will transfer the logic state of its input to the shift register 212 after a clock. Similarly, after a next clock, the shift register 212 will transfer the logic state of its input to the shift register 213. A gate clock is used to control the length of the shift clock of the shift register 10. In order to interpret the operation of the shift register unit 10 more clearly, reference is made to FIG. 3, which is an input/output waveform view of the conventional shift register.

The level shift unit 20 can shift a low-voltage logic level into a high-voltage logic level instantly. For example, in order to shift a low-voltage logic level 3V/0V into a high-voltage logic level 20V/−5V, reference is made to FIG. 4, which is an input/output waveform view of a conventional level shifter. That is, the level shifters. 221˜228 receive output low potential levels from the shift registers 211˜218, respectively, then shift the low potential levels into high potential levels and output them. The load may be different depending on different types of the display panel 60. Thus, the driving power may be insufficient if the outputs of the level shifters 221˜228 are used to drive the scanning lines of the display panel 60 directly. Therefore, an output buffer unit 40 is added to its post-circuit. The output buffer unit 40 includes a plurality of output buffers 241˜248 to enhance the driving power of digital signals from the level shifters 221˜228.

It should be noted, each channel of a gate driver need to be assigned a shift register and a level shifter in the conventional technology of FIG. 2A. This is not considered so far. However, with the development of technologies, the size of the display panel 60 is being designed to be larger, the amount of required shift registers and level shifters is considerable. If an equivalent function can be achieved through lesser number of components, it will reduce cost, reduce the space occupation and reduce the overall volume of the products.

Therefore, manufacturers of display panel are seeking for suitable solutions which can overcome the aforementioned problems.

### SUMMARY OF THE INVENTION

The present invention provides a gate driver, which uses a demultiplexer to divide an original signal into a plurality of signal parts and transmit the signal parts to corresponding gate channels in order to drive gate lines of a load.

In order to address the aforementioned problem, the present invention provides a gate driver including a signal generator and a demultiplexer. The signal generator can generate an original signal which has a plurality of gate driving periods during an actuating period. The demultiplexer is coupled to the signal generator, and can divide the original signal into a plurality of signal parts and transmit the signal parts to corresponding gate channels during the gate driving periods. The gate channels correspond to gate lines of a load, respectively.

According to an embodiment of the present invention, the signal generator of the gate driver includes a shift register, a signal combining logic device and a level shifter. The shift register can receive a start pulse and transmit it gradually within itself to output a plurality of first signals. The signal combining logic device is coupled to the shift register and can combine the first signals to form a second signal. The level shifter is coupled between the signal combining logic device and the demultiplexer, and can shift the level of the second signal as the original signal.

According to another embodiment of the present invention, the gate driver further includes a logic control device and a logic circuit. The logic control device outputs a plurality of controlling signals corresponding to the gate driver periods, and the logic circuit includes a plurality of logic gates to receive the original signal and each determine whether the original signal passes therethrough according to the controlling signals, thereby causing the original signal to be divided into a plurality of signal parts and transmitted to corresponding gate channels, respectively.

In the present invention, by utilizing a gate driver having a demultiplexer and dividing an original signal generated by a signal generator into a plurality of signal parts and transmit the signal parts to the corresponding gate channels, the amount of shift registers and level shifters required in front-end circuit, the manufacturing cost of the gate driver can be reduced and the space occupation of chip can be reduced.

### BRIEF DESCRIPTION OF THE DRAWINGS

These and other exemplary embodiments, features, aspects, and advantages of the present invention will be described and become more apparent from the detailed description of exemplary embodiments when read in conjunction with accompanying drawings.

FIG. 1 is a schematic circuit diagram illustrating a scanning drive circuit of a conventional display panel.

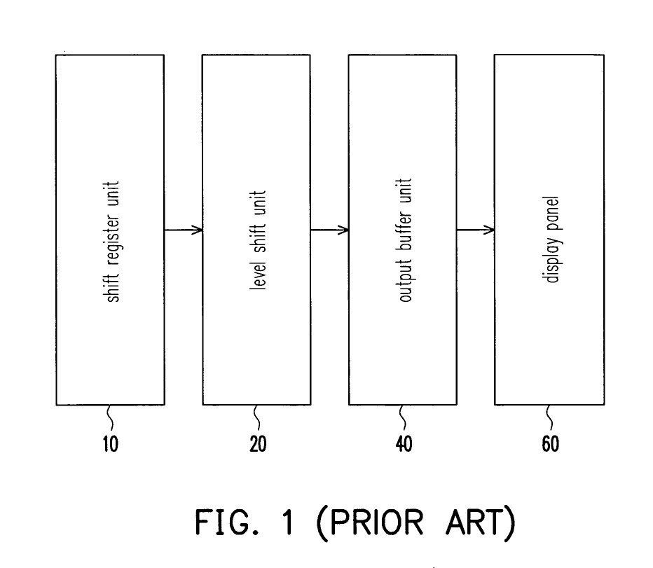

FIG. 2A is a schematic circuit diagram illustrating more details of a scanning drive circuit of a conventional display panel.

FIG. 2B is a signal sequence chart of a scanning drive circuit according to a preferred embodiment of the conventional display panel.

FIG. 3 is an input/output waveform view of the conventional shift register.

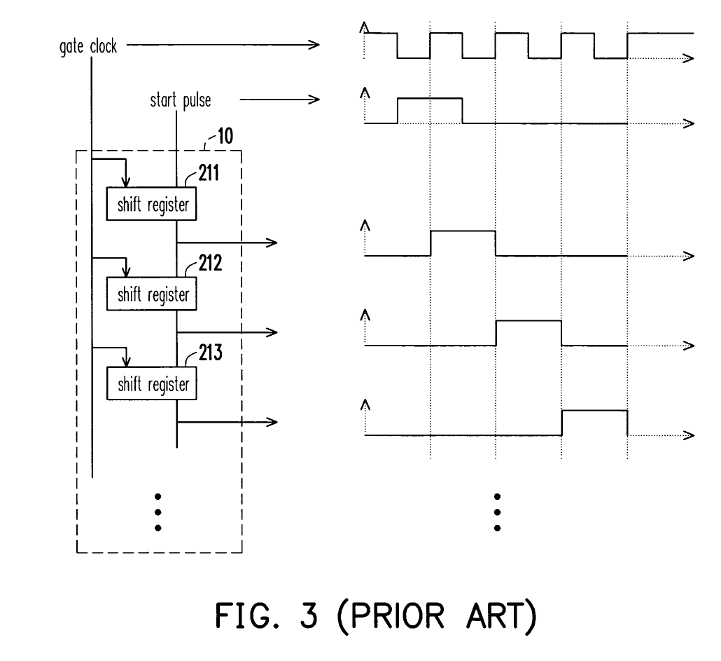

FIG. 4 is an input/output waveform view of the conventional level shifter.

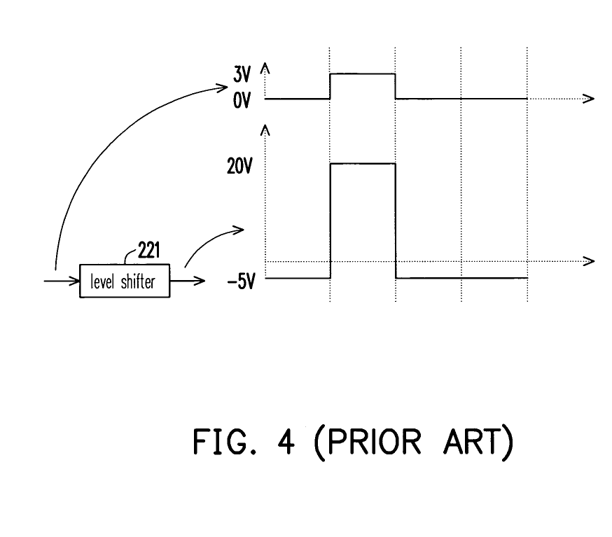

FIG. 5A is a schematic circuit diagram illustrating a gate driver according to a preferred embodiment of the present invention.

FIG. 5B is a schematic circuit diagram illustrating more details of a gate driver according to a preferred embodiment of the present invention.

FIG. 5C is a signal sequence chart of the gate driver of FIG. 5B.

FIG. 6 is a schematic, circuit diagram illustrating more details of a gate driver according to another preferred embodiment of the present invention.

FIG. 7 is a schematic circuit diagram illustrating more details of a gate driver according to still another preferred embodiment of the present invention.

FIG. 8A is a schematic circuit diagram illustrating more details of a gate driver with a demultiplexer arranged between a shift register unit and a level shift unit according to a preferred embodiment of the present invention.

FIG. 8B is a schematic circuit diagram illustrating more details of a demultiplexer according to a preferred embodiment of the present invention.

FIG. 9 is a schematic circuit diagram illustrating more details of a gate driver with another shift register unit according to a preferred embodiment of the present invention.

FIG. 10A is a schematic circuit diagram illustrating a gate driver including a logic control device according to a preferred embodiment of the present invention.

FIG. 10B is a schematic circuit diagram illustrating more details of a gate driver including a logic control device according to a preferred embodiment of the present invention.

### DESCRIPTION OF THE EMBODIMENTS

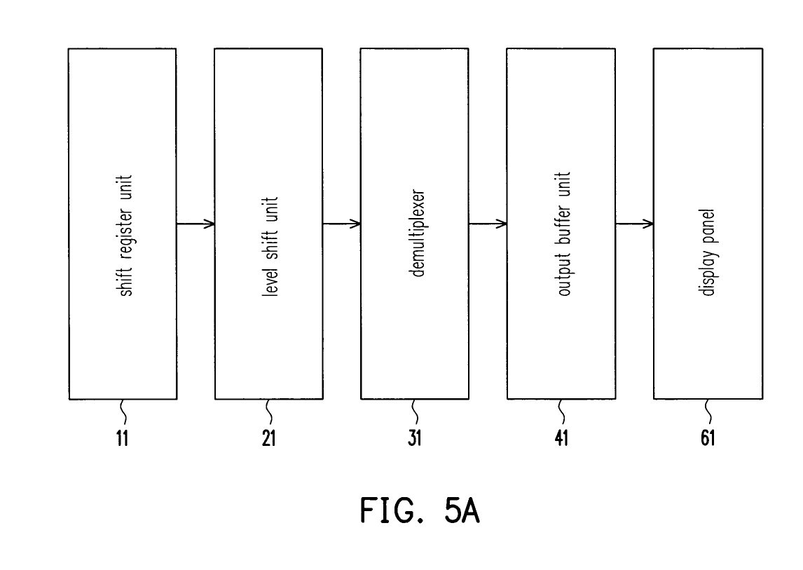

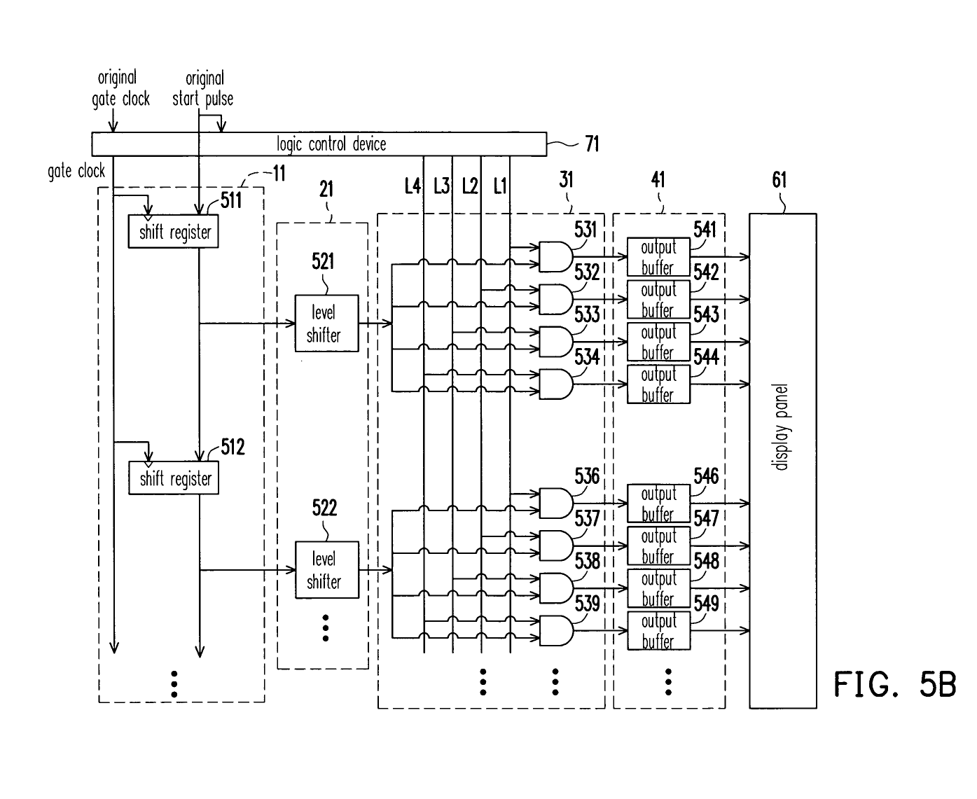

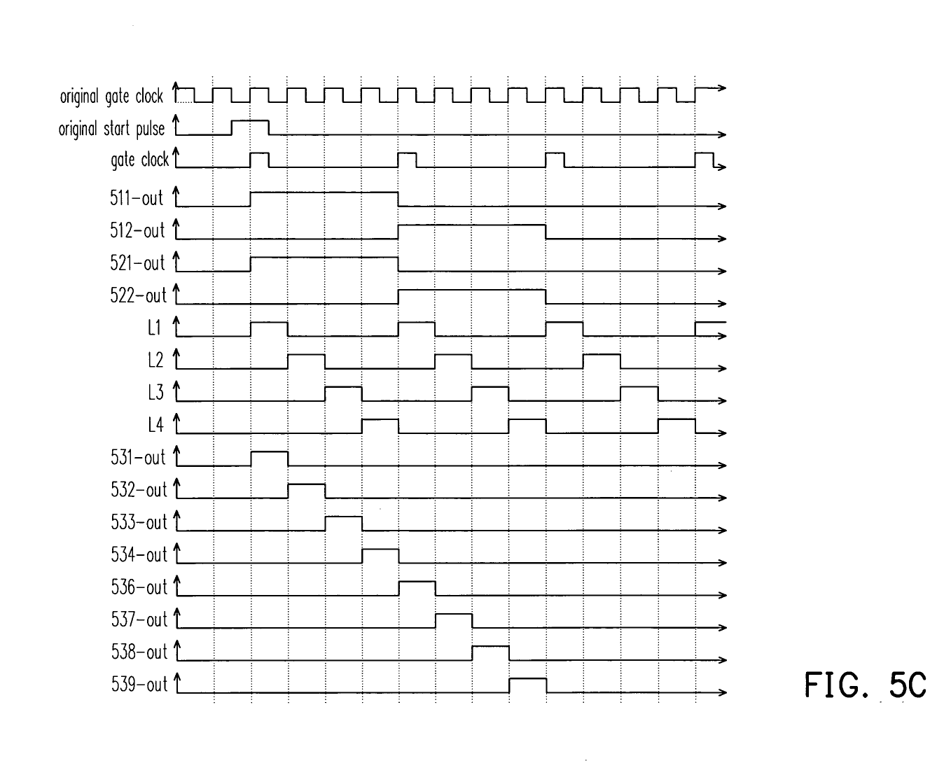

FIG. 5A is a schematic circuit diagram illustrating a gate driver according to a preferred embodiment of the present invention. The gate driver includes a signal generator, a demultiplexer 31, and an output buffer unit 41. In this embodiment, the signal generator includes a shift register unit 11 and a level shifter unit 21. The functions of the output buffer unit 41 and the display panel 61 can be performed as described above. It should be noted that by employing the demultiplexer 31, the number of components in the shift register unit 11 and the level shift unit 21 are reduced.

FIG. 5B is a schematic circuit diagram illustrating more details of a gate driver according to a preferred embodiment of the present invention. FIG. 5C is a signal sequence chart of the gate driver of FIG. 5B. Referring to FIG. 5B and 5C, in FIG. 5C, 511-out, 512-out respectively represent output signals of shift registers 511, 512, 521-out, 522-out respectively represent output signals of level shifters 521, 522, L1˜L4 respectively represent signals provided by connecting lines L1˜L4, and 531-out˜539-out respectively represent output signals of the “AND” gates 531˜539.

A logic control device 71 receives an original gate clock and an original start pulse from external, and then output gate clock having a longer period to the shift register unit 11. The shift register unit 11 receives the gate clock from the logic control device 71 and an original start pulse from external. In this embodiment, the period of the gate clock from the logic control device 71 is fourfold that of the original gate clock. During each gate clock, the shift register unit 11 transmits the original start pulse gradually within itself (shift register 511, 512, . . . ). That is, during a first period, the shift register 511 transmits the original start pulse to the shift register 512 and a level shifter 521, and then during a second period, the shift register 512 transmits the original start pulse to a shift register 513 and a level shifter 522. The remaining steps may be deduced by analogy, and therefore description thereof is omitted. When the level shifters 521, 522 have received output signals from the shift registers 511, 512, they can elevate the potential level of the signals and then output the signals having elevated potential level. Thus, the signal generator including the shift register unit 11 and the level shift unit 21 may generate a plurality of original signals to the demultiplexer 31.

It should be noted, in this embodiment, the demultiplexer 31 includes “AND” gates 531˜539. The “AND” gates 531˜539 each includes two inputs. One of the inputs is coupled to one of connecting lines L1˜L4, and another is coupled to the level shift unit 21. The “AND” gates 531˜534 receive an output signal from the level shifter 521, and the “AND” gates 535˜539 receive an output signal from the level shifter 522. The connecting lines L1˜L4 can gradually elevate potential levels (logic 1) during each unit time (a quarter of the gate clock ), and the remaining steps may be deduced by analogy. In other words, each “AND” gate functions as a switch, and the connecting lines L1˜L4 determine whether the output signal of the level shift unit 21 pass through the “AND” gates 531˜539. For example, the original signal 521-out generated by the signal generator has four gate driving periods during an actuating period. The “AND” gate 531 of the demultiplexer 31 switches a part of the plus width of the original signal 521-out to a corresponding gate channel (i.e. the output signal 531-out is output to the output buffer 541) during a first gate driving period. The “AND” gate 532 of the demultiplexer 31 switches a part of the plus width of the original signal 521-out to another corresponding gate channel (i.e. the output signal of 532-out is output the output buffer unit 542) during a second gate driving period. It can be deduced that the demultiplexer can divide the original signal into a plurality of signal parts and transmit the signal parts to the corresponding gate channels during the gate driving periods, and the gate channels can correspond to gate lines of a load, respectively.

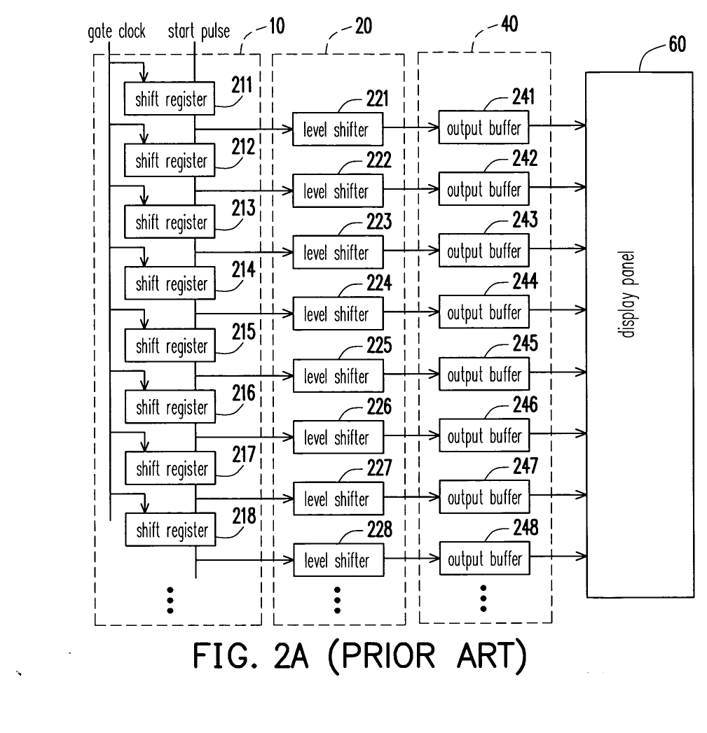

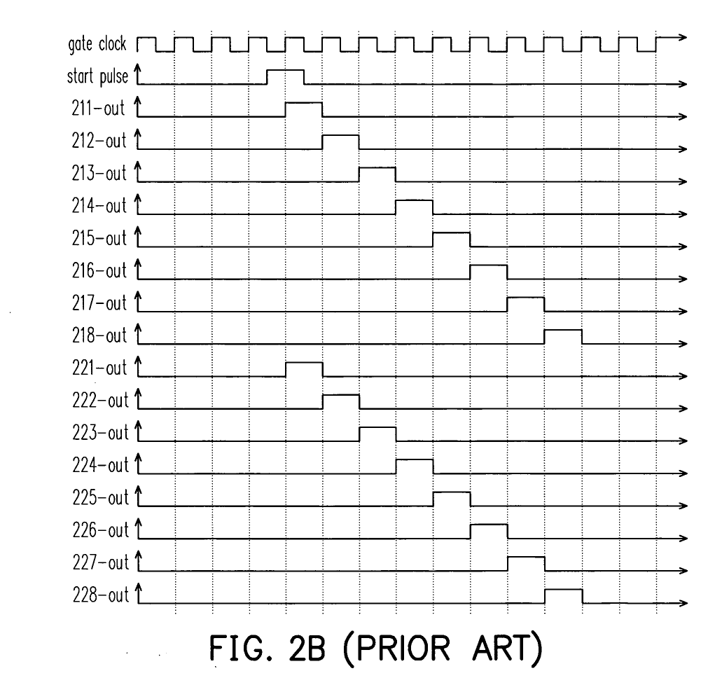

To emphasize advantages of preferred embodiments of present invention, the present invention is compared with conventional technologies. Comparing FIG. 2B with FIG. 5C, it can be seen that the 221-out˜228-out in FIG. 2B have same output signals as those of the 531-out˜534-out, 535-out˜539-out in FIG. 5C. Next, comparing FIG. 2A with FIG. 5B, it can be seen that the number of components used in the preferred embodiment of the present invention is significantly reduced. In the preferred embodiment of the present invention, because of the connecting lines L1˜L4 and the “AND” gates 531˜534, 536˜539 provided by the demultiplexer 31, the amount of the shift registers and the level shifters is by four folds compared to those used in the conventional technologies. Thus, the number of components can be significantly reduced, and the cost can also be reduced. Table 1 shows the difference between the conventional technologies and the preferred embodiment of the present invention, the difference of components is listed in the following table.

TABLE 1
difference between conventional technology and the preferred
embodiment of the present invention

| | conventional | a preferred embodiment of |
|---|---|---|
| | technology | the present invention |
| the number of shift register | 8 | 2 |
| the number of level shifters | 8 | 2 |

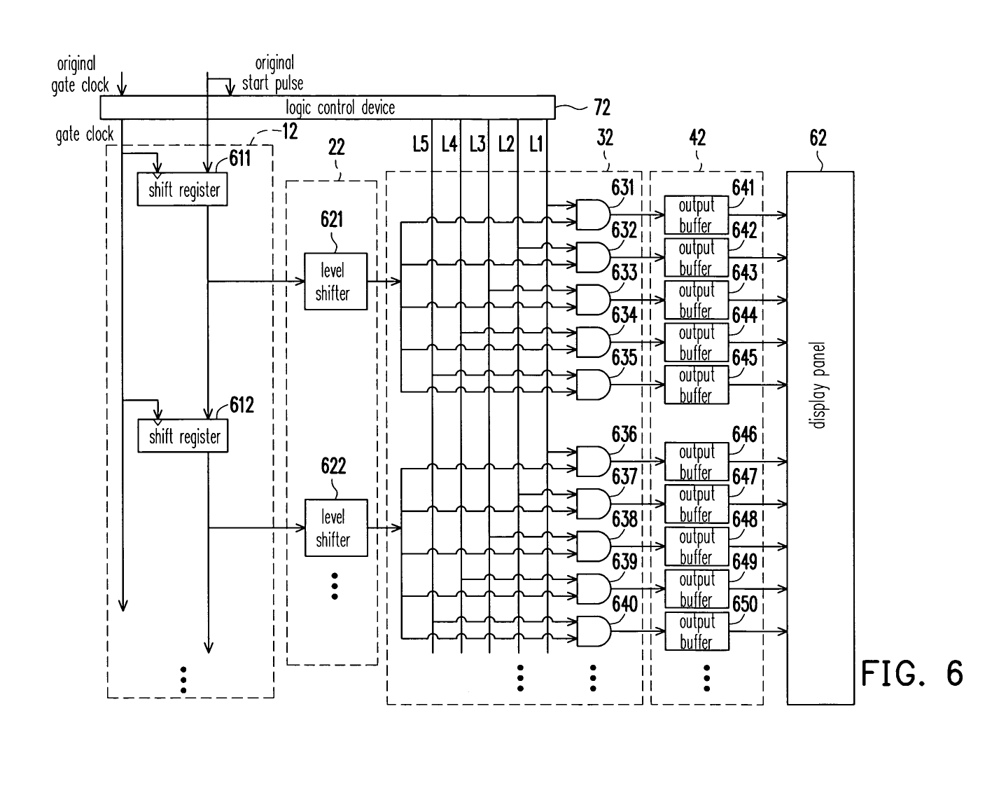

If desired, those of ordinary skill in the art can change the number of connecting lines according to the teachings of embodiments of the present invention described above. FIG. 6 is a schematic circuit diagram illustrating more details of a gate driver according to another preferred embodiment. The functions of a shift register unit 12, a level shifter unite 22, a demultiplexer 32, an output buffer unit 42, a logic control device 72, and a display panel 62 are similar to those in FIG. 5B, and thus being omitted. It should be noted that four connecting lines L1˜L4 in previous embodiment are changed to five connecting lines L1˜L5 in this embodiment. In order to match with the connecting lines L1˜L5, the period of gate clock is prolonged by a unit time. Thus, the number of shift registers and level shifters may be ⅕^{th} of those of the convention technology. This can greatly reduce the cost and also reduce the space occupation of a chip.

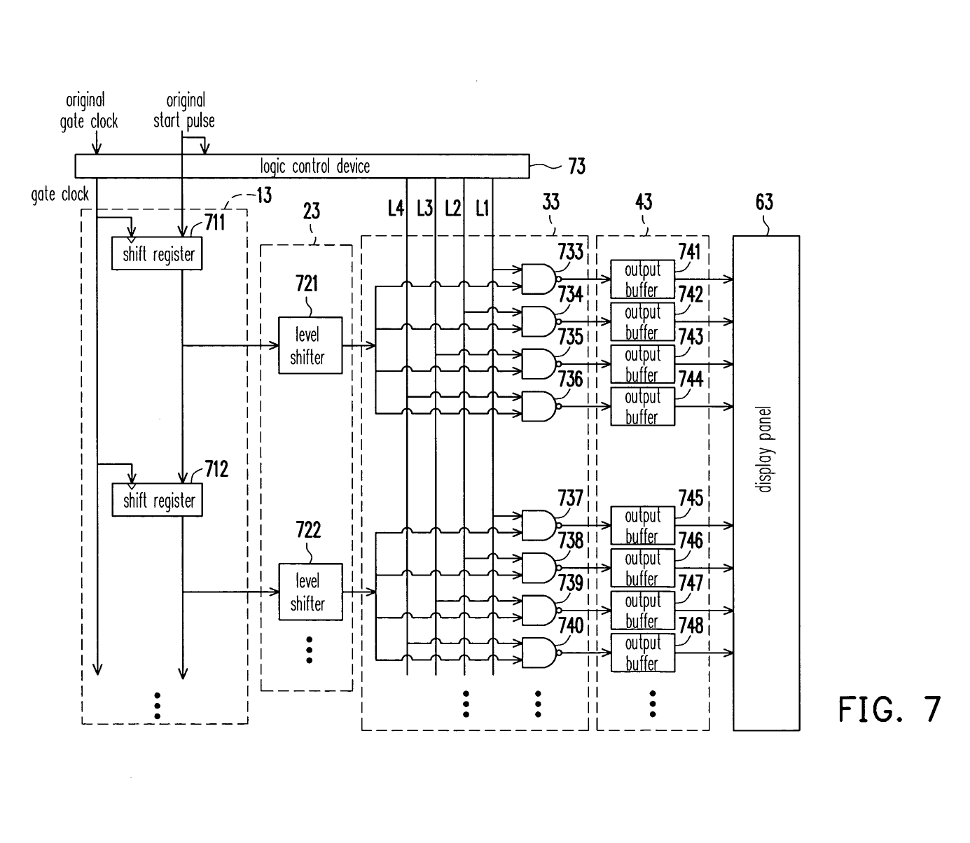

If desired, those of ordinary skill in the art can substitute the “AND” gates with other suitable logic gates and correspondingly adjust the demultiplexer and the output buffer unit according to the teachings of the embodiments of the present invention described above. For example, FIG. 7 is a schematic circuit diagram illustrating more details of a gate driver according to still another preferred embodiment, the functions of a shift register 13, a level shifter 23, a demultiplexer 33, an output buffer unit 43, a logic control device 73, and a display panel 63 are similar to those described with reference to FIG. 5B, and description thereof is omitted. It should be noted, due to characteristics of easy to manufacture and lower cost of “NAND” gates, the “AND” gates 531˜534, 536˜539 is replaced by “NAND” gates 733˜740 in the demultiplexer 33. Although the “NAND” gates 733˜740 may invert logic states of the previous embodiment, the logic states can be inverted again in the output buffer unit 43 in which output buffers 741˜748 are achieved by “NOT” gates, a same buffer operation can be achieved at the same time. Thus, the gate driver comprising of “NAND” gates having lower cost and the output buffer unit 43 may achieve same operations as those of the previous embodiment.

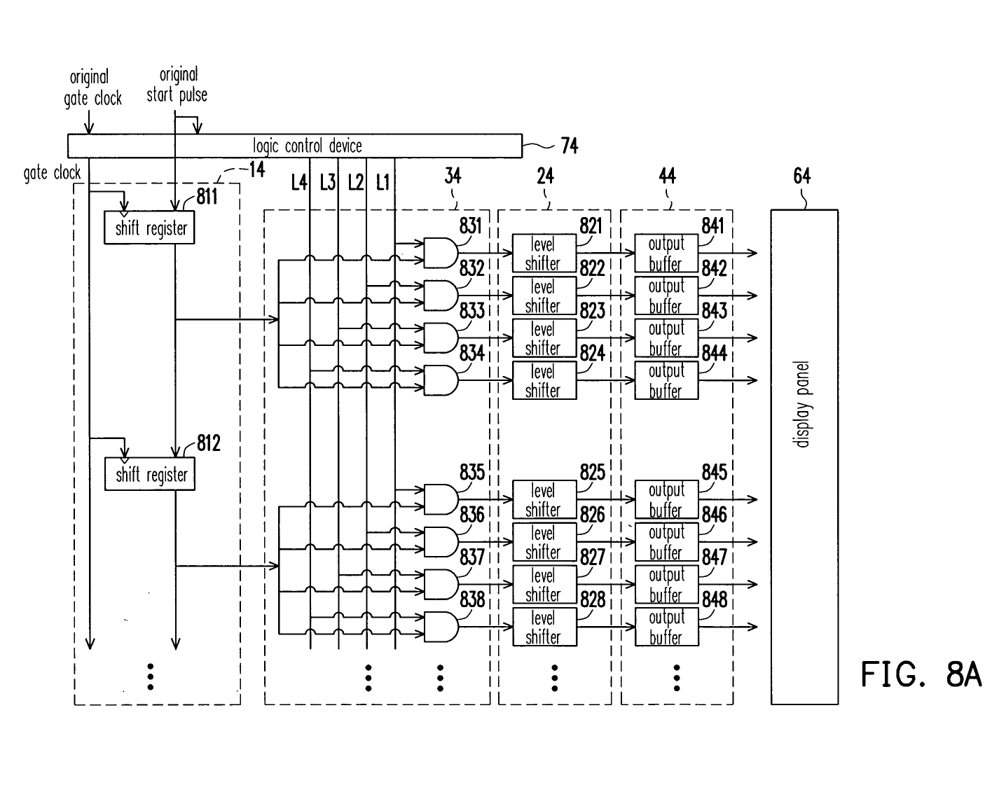

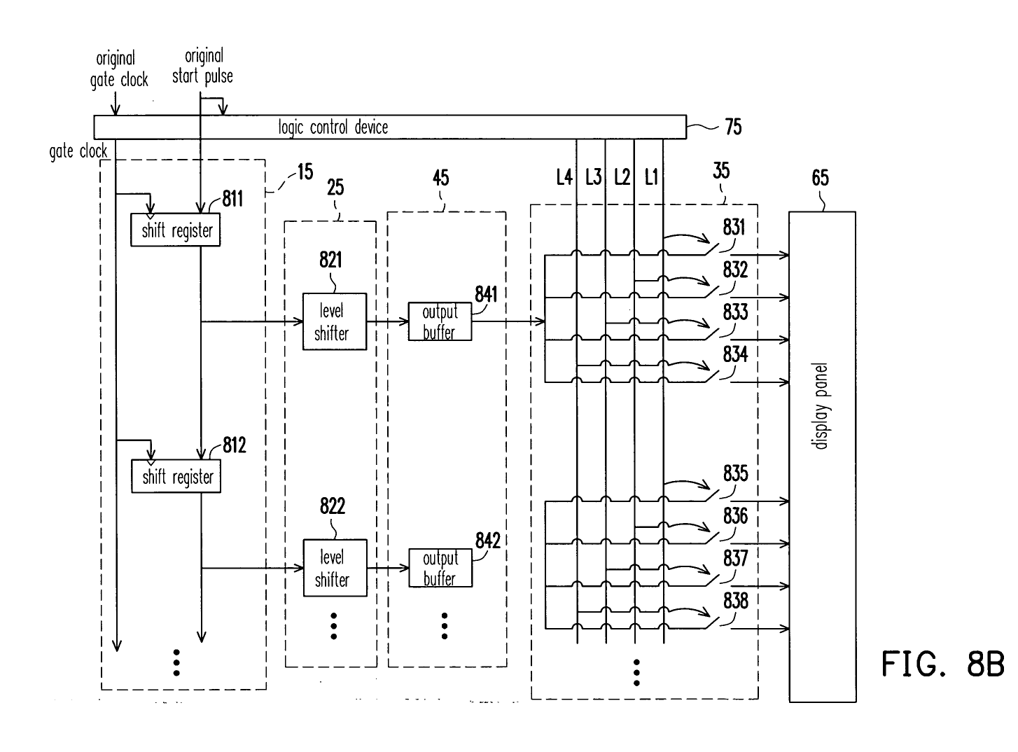

If desired, those of ordinary skill in the art can rearrange the demultiplexer 31 at various dispositions and correspondingly adjust circuits according to the teachings of embodiments of the present invention described above. For example, FIG. 8A is a schematic circuit diagram illustrating more details of a gate driver with a demultiplexer arranged between a shift register unit and a level shift unit according to a preferred embodiment of the present invention. In this embodiment, a signal generator includes a shift register unit 14. The functions of the shift register unit 14, a level shifter unit 24, a demultiplexer 34, an output buffer unit 44, a logic control device 74, and a display panel 64 are similar to those described with reference to FIG. 5B, and the description thereof is omitted. It should be noted that the demultiplexer 34 is arranged between the shift register 14 and the level shifter 24. Thus, the demultiplexer 34 may have a same operation voltage range as that of the shift register 14, which can reduce the number of shift registers.

Referring to FIG. 8B, FIG. 8B is a schematic, circuit diagram illustrating more details of a demultiplexer 35 according to a preferred embodiment of the present invention. In this embodiment, a signal generator includes a shift register unit 15, a level shift unit 25, and an output buffer unit 45. The functions of the shift register unit 15, the level shifter unit 25, the demultiplexer 35, the output buffer unit 45, a logic control device 75, and a display panel 65 are similar to those described with reference to FIG. 5B, and therefore description thereof is omitted. It should be noted that the demultiplexer 35 is arranged between the output buffer unit 45 and the display panel 65, and the “AND” gates of the previous embodiment are replaced by switches 831˜838, which can be controlled by controlling signals sent through connecting lines L1˜L4. The switches 831˜838 may be, for example, metal oxide semiconductor transistors. This may reduce the number of shift registers, level shifters and output buffers.

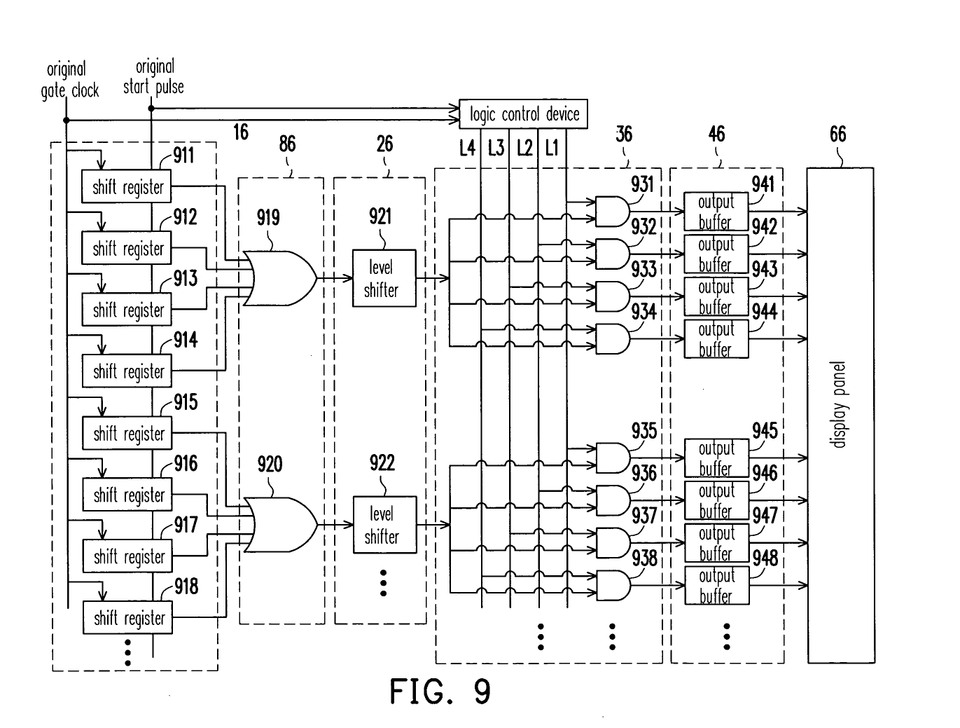

If desired, those of ordinary skill in the art can change implementation of the shift register unit 31 according to the teachings of embodiments of the present invention described above. FIG. 9 is a schematic circuit diagram illustrating more details of a gate driver with another shift register unit according to a preferred embodiment of the present invention. A signal generator includes a shift register unit 16, a signal combining logic device 86, and a level shifter 26. The signal combining logic device 86 includes a plurality of OR gates 919, 920. The functions of the shift register 16, the level shifter 26, a demultiplexer 36, an output buffer unit 46, and a display panel 66 are similar to those described with reference to FIG. 5B, and description thereof is omitted. It should be noted, the shift registers 911˜914 of the shift register unit 16 cooperate with an OR gate 919 to replace the shift register 511 shown in FIG. 5B, and the shift registers 915˜918 of the shift register unit 16 cooperate with an OR gate 920 to replace the shift register 512 shown in FIG. 5B. An advantage of this arrangement is that the impulse width of the original start pulses can be more flexible. Provided that the pulse width of an initial original start pulse of this embodiment is one unit time, and the period of an initial gate clock is one unit time. The impulse width of the output original start pulse can be four times that of the period of an initial gate clock through the OR gates 919, 920. Next, the demultiplexer 36 and the gates 931˜934, 935˜938 are used to decode. Of course, the OR gates 919 can also be changed to have three inputs, which may change the pulse width of output original start pulse to be three times that of the period of an initial gate clock to provide the output original start pulse to three “AND” gates for decoding. This arrangement can even be more flexible by cooperating with OR gates having different numbers of inputs.

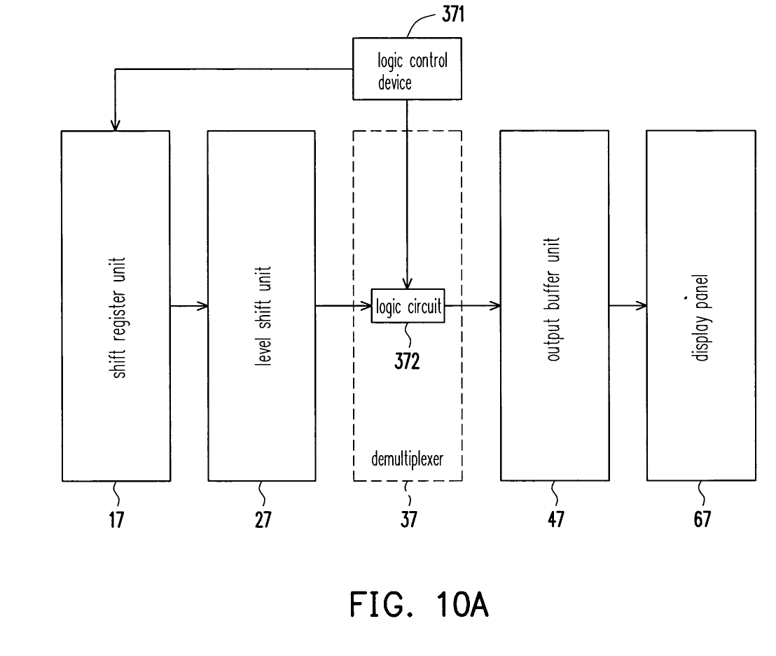

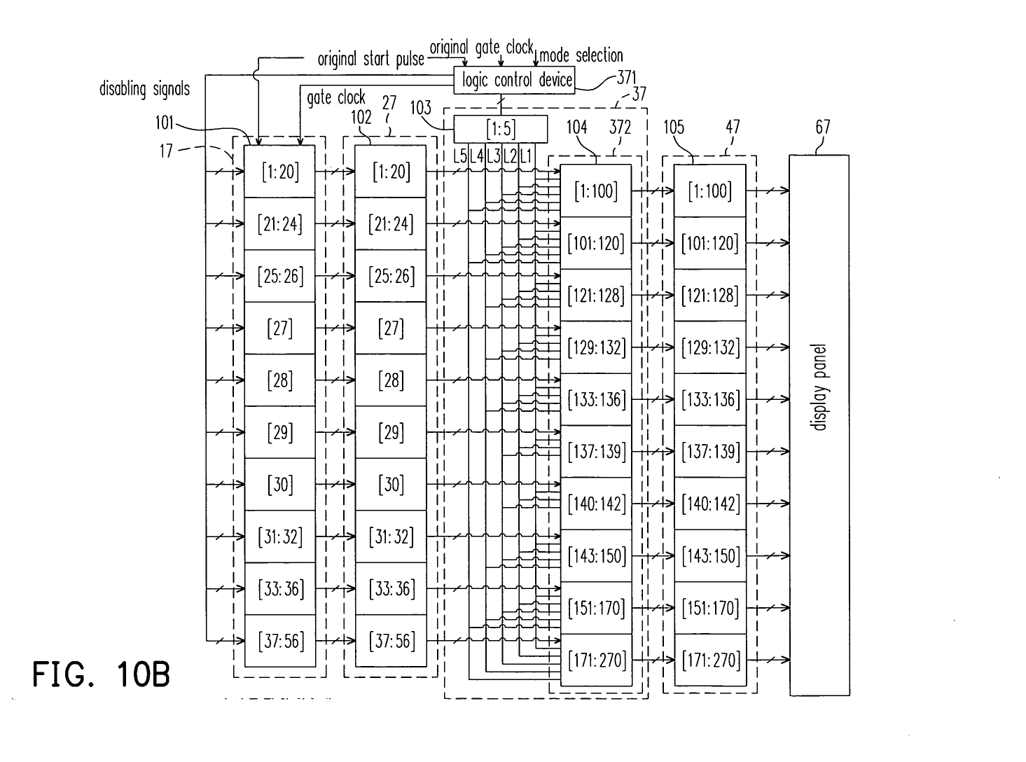

The demultiplexer may include a logic control device according to another embodiment of the present invention. FIG. 10A is a schematic structural view showing more details of a gate driver including a logic control device according to a preferred embodiment. The functions of a shift register 17, a level shifter 27, a demultiplexer 37, an output buffer unit 47, and a display panel 67 are similar to those shown in FIG. 5B, and thereof the description thereof is omitted. For example, the display panel 67 is a liquid crystal display panel. The versatility of a gate driver is a major part of cost consideration, that is, if the gate driver can have different numbers of inputs so as to cooperate with liquid crystal display panels having different sizes, the field of application will be increased greatly. Mass production and reduced cost of the gate driver can be achieved. It should be noted, the logic control device 371 of the demultiplexer 37 may control the number of outputs to adapt to liquid crystal display panels having different sizes.

FIG. 10B is a schematic circuit diagram illustrating more details of a gate driver including a logic control device according to a preferred embodiment. The shift register unit 17 includes an array of shift registers 101, and the level shifter unit 27 includes an array of level shifters 102. The demultiplexer 37 includes an array of level shifters 103 and a logic circuit 372. The array of level shifters 103 includes five level shifters, which receive controlling signals of connecting lines L1˜L5 for the logic control device. The logic circuit 372 includes an array of “AND” gates 104. The output buffer unit 47 includes an array of output buffer 105. The array of shift registers 101 includes fifty six shift registers divided into ten groups. The array of level shifters 102 includes fifty six level shifters divided into ten groups. The array of “AND” gates 104 includes two hundred and seventy “AND” gates divided into ten groups. The array of output buffers 105 includes two hundred and seventy output buffers divided into ten groups. That is, the gate driver may provide two hundred and seventy outputs divided into ten groups. For purpose of clarity, the amounts of components in each group are listed in Table two.

Table 2 illustrates the amount of components of each group in a gate driver. It can be seen from Table 2, the amounts of shift registers and level shifters in group 1 both are 20. By employing five connecting lines, the number of “AND” gates and output buffers are 100. Groups 2-10 can be deduced similarly, thus will be not described in detail. The logic control device 371 may control a period of a gate clock. Provided that a period of an initial gate clock is five unit times, when an initial original start pulse is input to the group 1 from external, the logic control device 371 may send a gate clock having a period of five unit times to the group 1 simultaneously. The original start pulse is gradually transmitted within the group 1. After transfer in the group 1 has been completed, the original start pulse can be transferred to the group 2, subsequently. The logic control device 371 may adjust the periods of gate clocks according to the number of connecting lines of different groups. When the original start pulse is transmitted from the group 1 to the group 2, the logic control device 371 may adjust the period of gate clocks to five basic times. That is, all periods of gate clocks received by the other groups are five unit times. When the original start pulse is transmitted from the group 2 to the group 3, the logic control device 371 may adjust the period of gate clocks to four basic times. That is, all periods of gate clocks received by other groups are four unit times. The remaining groups can be deduced similarly, and will not be described in detail.

TABLE TWO
component amount of each group of gate driver

| | Shift | | | | Output |
|---|---|---|---|---|---|
| | register | Lever shift | Connecting | AND gate | buffer |
| | array 101 | array 102 | line | array 104 | array 105 |
| group 1 | 20 | 20 | 5 | 100 | 100 |
| group 2 | 4 | 4 | 5 | 20 | 20 |
| group 3 | 2 | 2 | 4 | 8 | 8 |
| group 4 | 1 | 1 | 4 | 4 | 4 |
| group 5 | 1 | 1 | 4 | 4 | 4 |
| group 6 | 1 | 1 | 3 | 3 | 3 |
| group 7 | 1 | 1 | 3 | 3 | 3 |
| group 8 | 2 | 2 | 4 | 8 | 8 |
| group 9 | 4 | 4 | 5 | 20 | 20 |
| group 10 | 20 | 20 | 5 | 100 | 100 |
| Sum | 56 | 56 | | 270 | 270 |

The logic control device 371 also can provide controlling signals to the connecting lines L1˜L5. That is, when each groups receive the original start pulse, the logic control device 371 can adjust controlling modes according to the amount of connecting lines in different groups. Such as, when the group 1 receives the original start pulse, the logic control device 371 may gradually provide potential level of logic 1 to the connecting lines L1˜L5. When the group 2 receives the original start pulse, the logic control device 371 may gradually provide potential level of logic 1 to the connecting lines L1˜L5. When the group 3 receives the original start pulse, the logic control device 371 may gradually provide potential level of logic 1 to the connecting lines L1˜L4. The rest may be deduced by analogy. 270 registers required in the conventional technology can be replaced by 56 shift registers and 56 level shifters. The gate driver according the embodiments can achieve the same performance by using less number of devices, which can greatly reduce the cost.

The logic control device 371 also can control the actuating states of the shift register 17 in different groups. Presently, a normal number of outputs of a gate driver may be 270, 263, 256, 240, or 200. Of course, the number of outputs may be adjusted as needed. The implementation of 270 outputs has been described. When a user needs 263 outputs, the logic control device 371 may achieve so by sending disabling signals to turn off the groups 5, 6. Similarly, if a user needs 256 outputs, the logic control device 371 may achieve so by sending disabling signals to turn off the groups 4˜7. If a user needs 240 outputs, the logic control device 371 may achieve so by sending disabling signals to turn off the groups 2˜9. This can result in an improved versatility of the gate driver and contribute in reducing the manufacturing cost.

As mentioned above, in the preferred embodiment of the present invention, an original signal can be generated using a signal generator, and be sent as a decoding signal through a plurality of connecting lines of a demultiplexer, thereby a long-period signal can be divided into a plurality of signal parts and then sent out. The number of shift registers and level shifters in front-end circuit is reduced, the manufacturing cost is reduced and the chip space occupation is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gate driver, comprising:
a signal generator, for generating at least one original signal having a plurality of gate driving periods during an actuating period; and
a demultiplexer, coupled to the signal generator, for dividing the original signal into a plurality of signal parts and transmitting the signal parts to a corresponding gate channel during the gate driving periods, wherein the gate channel corresponds to a gate line of a load.

2. The gate driver according to claim 1, wherein the signal generator comprises:
a shift register, for receiving an start pulse and transmitting the start pulse gradually within itself to output the original signal.

3. The gate driver according to claim 1, wherein the signal generator comprises:
a shift register, for receiving an start pulse and transmitting the start pulse gradually within itself; and
a level shifter, coupled to the demultiplexer and the shift register, for shifting the output level of the shift register as the original signal.

4. The gate driver according to claim 1, wherein the signal generator comprises:
a shift register, for receiving an start pulse and transmitting the start pulse within itself to output a plurality of first signals;
a signal combining logic device, coupled to the shift register, for combining the first signals into a second signal; and
a level shifter, coupled to the demultiplexer and the signal combining logic device, for shifting the level of the second signal as the original signal.

5. The gate driver according to claim 4, wherein the signal combining logic device comprises:
an “OR” gate, coupled to the shift register, for receiving the first signals and outputting the second signal.

6. The gate driver according to claim 1, further comprising a logic control device to output a plurality of controlling signals corresponding to the gate driving periods.

7. The gate driver according to claim 6, wherein the demultiplexer comprises:
a logic circuit, having a plurality of logic gates for receiving the original signal and respectively determining whether the original signal passes therethrough according to corresponding controlling signals, so as to divide the original signal into a plurality of original signal parts and transmitting the original signal parts to a corresponding gate channel during the gate driving periods.

8. The gate driver according to claim 7, wherein each of the logic gates comprises:
a “NAND” gate, including a first input for receiving the original signal, and a second input for receiving the corresponding controlling signal and an output coupled to the corresponding gate channel.

9. The gate driver according to claim 1, further comprising an output buffer unit coupled to the demultiplexer for enhancing driving power of the demultiplexer and transfer the output of the output buffer unit to a gate line of the load.

10. The gate driver according to claim 1, further comprising:
a level shifter, coupled to the demultiplexer, for shifting the output level of the demultiplexer; and
an output buffer unit, coupled to the level shifter, for enhancing driving power of the level shifter and transferring the output of the output buffer unit to a gate line of the load.

11. The gate driver according to claim 1, wherein the load is a display panel.

12. The gate driver according to claim 1, wherein the load is a liquid crystal display panel.
